(19) United States
(12) Patent Application Publication
(10) Pub. No.: US 2010/0100432 A1
(43) Pub. Date: Apr. 22, 2010

(54) Incentive method and apparatus

(76) Inventor: Bernhard Kreten, Alexandria, VA (US)

Correspondence Address: Weintraub Genshlea Chediak Law Corporation, 11th Floor, 400 Capitol Mall, Sacramento, CA, 95814, US

(21) Appl. No.: 12/288,507

(22) Filed: Oct. 20, 2008

(51) Int. Cl. G06Q 30/00

(52) U.S. Cl. 705/14.14

(57) ABSTRACT

Instrumentality for promulgating worker quality and persistence in the workplace and user loyalty and patronage on the internet. A plurality of awards arranged in tiers is provided. One tier preferably is derived from the worker/user when selecting one or more awards from a menu of possible awards. Another tier is preferably provided by the employer/internet provider. A further tier is preferably in the form of a pecuniary award having a value which increments as a function of collective worker/user performance and which is preferably visible to the worker/user on a display until the award is won. Thereafter, the award resets to a base value.

### FIELD OF THE INVENTION

This method and apparatus relates to techniques which provide incentives to employees to perform with optimal efficiency and for internet users to patronize selected sites.

### BACKGROUND OF THE INVENTION

Behavior modification can take many forms, but it is believed that an award system is most effective in providing motivation. Motivational awards have been chronicled in the past, but most seem to be constrained in recognizing what constitutes adequate incentive for the sought after behavior.

For example, U.S. Pat. No. 6,049,779 teaches the use of an award system for employees in a call center which increments salary as a function of employer defined metrics. First, it appears the increments are perceived by the employee as an adjustment to base pay; in effect, it is likely perceived as a realignment of pay to a fair level from an unfair level based on the premise the employee has been underpaid. It should be noted that conscientious employees are “hard wired” to perform well, and that those less conscientious will likely not find the award as anything but an affront. Other patents electronically linked to this patent share the same perception of linearly linking remuneration to effort and likewise suffer from this shortcoming

### SUMMARY OF THE INVENTION

The present invention is distinguished over the known prior art in a multiplicity of ways. For example, it has been observed that the level of participation in state sponsored lotteries or in casinos rises remarkably when the cash award reaches very large amounts. Thus, to the extent that size matters, the instant invention preferably includes a large award to provide optimum incentive. For companies adopting this system, small businesses would normally be excluded from participation, but the instant invention accommodates all businesses, including small ones by pooling the contributions of businesses, in a manner analogous to subscription fees, into an administrative body which oversees the large awards for the benefit of the businesses' employees. Internet patronage may follow the same course. Distribution of the award follows a statistical algorithm assuring solvency of the administrative mechanism and program.

The present invention also allows employees and internet users to select tangible prizes from a menu to reflect personal desires. Each prize is preferably weighted as to value and also follows an algorithm for distribution to maintain solvency of the program. If a prize is not on the menu, it can be requested, assessed for propriety, availability and weighted according to an algorithm to be included in the menu. In this way, the award can be personalized for added incentive.

The present invention further allows third parties, as well as participating businesses and internet sources, to submit their products and services for inclusion on the menu. As a consequence, these sources' offers can be a form of advertising. While an algorithm may weight the value of the product or service as to its nominated value, it may also be offered for a promotional value and weighted in a modified manner. The product offered can be new or used.

### OBJECTS OF THE INVENTION

Accordingly, it is a primary object of the present invention to provide a new and novel incentive instrumentality.

A further object is to provide an incentive method and apparatus which includes, inter alia, a plurality of computer stations operatively connected to a network, said network operatively coupled to a means for monitoring at least one activity performed on each said computer station in said network, means to rank said activity based on at least one rule set accessible by said monitoring means, means for evaluating said ranking for each said computer station such that upon a condition occurring for at least one said computer station an output signal is generated and fed to a random award means, said random award means displaying to said one said computer which has been identified by said evaluating means a chance to receive an award, and means to activate said random award means on said one said computer station.

A further object includes the foregoing paragraphs and further provides selecting awards available from said random awards means as a function of input from each person who uses one of said computer stations and means, linked to said network, to identify each said person while said person is using said computer station.

A further object includes the foregoing paragraphs and provides adding a pecuniary award and includes means to increment its present value and display the present value at each said computer station.

A further object includes the foregoing paragraphs and further provides awards not based on input from each said person who uses one of said computer stations.

A further object includes the foregoing paragraphs and further provides configuring said random award activating means such that, upon the occurrence of an award due to the person using said computer station, means are provided to deliver the award from a remote site to a designated place.

Other objects shall become manifest upon considering the ensuing description.

### DESCRIPTION OF THE DRAWINGS

FIG. 1 is a flow chart that depicts certain facets of the invention and defines a network.

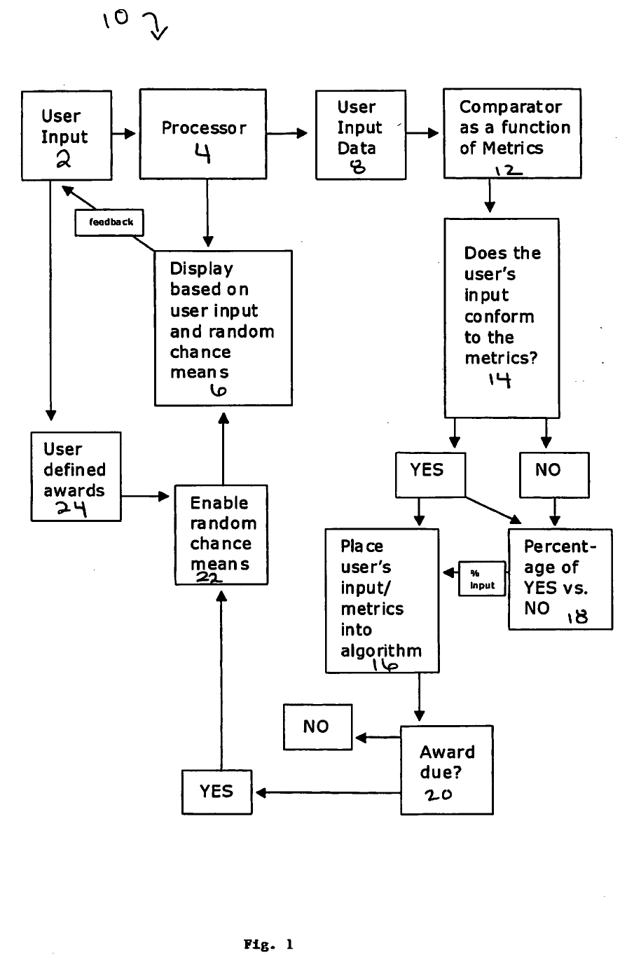

### DESCRIPTION OF THE PREFERRED EMBODIMENT

Reference numeral 10 is directed to the incentive method and apparatus according to the present invention. User input 2 is typically in the form of a keyboard, but, in the workplace, it may embrace voice recognition systems, bar code scanners, joy sticks, conveyor systems, control systems for automated machines or assembly lines, radiative type sensors such as optical, auditory, infrared, cell phones and other communication devices such as those communication devices that link two entities, as by radio frequency or other communicative radiation or medium, etc. In short, any input for which a person has the ability to control the rate and quality of the work being performed. A common example of rate would be volume of production or throughput as well as time management. An example of quality would be conformance with tolerances, customer satisfaction, and the user's initiative for continuing education and demonstrated product knowledge. In the case of internet usage, the historical input has been the keyboard, and, more recently voice or camera input, and joy stick type controls common for games. While one user input 2, processor 4 and display 6 are depicted, more inputs, processors and displays (as well as other components to be discussed) are within the ambit of the invention as should now be clear to one skilled in the art. These inputs may be oriented parallel to each other. The terms “worker”, “user” and “person” are interchangeable for clarity and ease of explanation. Where more than one person is to use one input 2 (i.e. computer station), each person will have a unique identifier to use the input 2.

To the extent necessary for the person to perform the task at hand, a processor 4 is operatively coupled to the user input 2. The processor 4 provides at least two outputs: one to a display 6 and another to a data transfer 8 of at least some of the user's input. Collectively, the input 2, processor 4 and display 6 define a workstation. The display 6 is preferably accessible to the user. The data transfer 8 extracts criteria necessary to provide the incentive process and feeds that data to a comparator 12 which analyzes the data from a plurality of user efforts and ranks these efforts. Typically these efforts are compared to standards or metrics unique to the person's task(s). While the metrics useful to the workplace have been illustrated above, examples of internet metrics may include: sites visited, purchases made on line, duration of use, and other forms of patronage which are to be rewarded by incentives. The comparator 12 receives the metrics to form its analysis from an employer or internet presence which has a vested interest in encouraging usage of a certain quality by providing incentives. The comparator 12 poses and resolves the question 14 of whether the person has an input quality that conforms to the metrics of interest. If the input conforms, a signal is fed to an algorithm 16 and preferably a storage device 18. If not, a signal is also fed to the storage device 18 which, in turn feeds the algorithm 16, providing an efficiency quotient of the person's usage patterns via a rule set. The algorithm 16 leads to a node 20 which branches the algorithm's output into a routine for sequencing an award opportunity or not.

An award opportunity initializes a random chance means 22 which feeds the person's display 6. The universe of awards available may be defined by the employer, an internet entity, a third party or the person using the workstation. The person may define either the entire universe of awards or preferably a subset thereof, preferably selected from a menu and inputs the desired award(s) 24. Where the menu lacks an award that is desired, it may be submitted for feasibility, availability, propriety or other criteria. Each award has its own individual value, and that value is melded into the random chance means 22. The objective is to rank the more valuable awards to have a lesser chance of being distributed than awards of lesser value, preferably according to formulae which assures fiscal solvency for the incentive program.

Because small entities may not be able to afford extravagant awards, those entities are prime candidates to become subscribers to the incentive method and apparatus so as to pool their resources to realize the possibility of large awards. This pooling is preferably managed by an independent administrative entity. In such an event, the metrics used in the comparator 12 require scrutiny to assure that each business entity subscribing to the incentive program has a metric profile which has been statistically normalized to assure uniformity of outcomes and parity. One added feature provides a pecuniary outcome as an award, and having the value of the award increment as a function of performance in accord with the metric constraints. This incrementing value is preferably discernible to the persons via the displays 6.

In use and operation, a person is identified when embarking upon the workstation. As the person utilizes the workstation, an analysis is made to determine the extent to which the utilization conforms to the pre-established metrics. An evaluation is made resulting in either storing the performance history or enabling the random chance award generator. Winning is accompanied by delivery of the award.

It should now be apparent that modifications are possible, but the scope of the invention is to be construed in light of the claims.

1. An incentive apparatus comprising, in combination:
a plurality of computer stations operatively connected to a network, said network operatively coupled to a means for monitoring at least one activity performed on each said computer station in said network,
means to rank said activity based on at least one rule set accessible by said monitoring means,
means for evaluating said ranking for each said computer station such that upon a condition occurring for at least one said computer station an output signal is generated and fed to a random award means, said random award means displaying to said one said computer station identified by said evaluating means a chance to receive an award, and
means to activate said random award means on said one said computer station.

2. The apparatus of claim 1 further comprising means to select awards available from said random awards means as a function of input from each person who uses one of said computer stations and means, linked to said network, to identify each said person while said person is using said computer station.

3. The apparatus of claim 1 further comprising means to provide a pecuniary award, means to increment its present value and means to display the present value at each said computer station.

4. The apparatus of claim 1 further comprising means to define two types of awards: a first said type not based on input from each said person who uses one of said computer stations and a second said type based on menu means operatively accessible to each said person to customize awards.

5. The apparatus of claim 4 further including means for each person to request an award not on said menu, and means operatively coupled to said apparatus to value said requested award for possible inclusion as an award.

6. The apparatus of claim 1 further comprising means to configure said random award activating means such that upon the occurrence of an award due the person who uses said computer station, means to direct a delivery of the award from a remote site to a designated place.

7. An incentive method, the steps including:
providing a plurality of user inputs,
analyzing said inputs for conformance to desired activities,
providing a plurality of awards to be randomly available only after the conformance analysis directs that a threshold level has been met,
activating the user input which merits a chance at a random award to partake in the chance,
enabling a random chance means,
displaying results from the random chance means to the user input, and
providing an award to the user of the input if so directed by an outcome of the random chance means.

8. The method of claim 7 further including tailoring the award from at least one of the following: a fixed menu of awards, a pecuniary award which increments as a function of conforming activity, and an award selected by a user of the input.
